(19) United States
(12) Patent Application Publication
(10) Pub. No.: US 2004/0222243 A1
(43) Pub. Date: Nov. 11, 2004

(54) Low-cost, in-line trigger operated pump sprayer

(75) Inventor: Steve L. Sweeton, Lake Winnebago, MO (US)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: Saint-Gobain Calmar Inc.

(21) Appl. No.: 10/836,384

(22) Filed: May 3, 2004

Related U.S. Application Data
(60) Provisional application No. 60/468,642, filed on May 8, 2003.

(51) Int. Cl. G01F 11/06

(52) U.S. Cl. 222/383.1

(57) ABSTRACT

A low-cost, in-line trigger actuated pump sprayer has a pump body which may have an integral container closure and/or integral shroud cover with a trigger lever trunnion mounted to the pump body or with a trigger lever assembly mounted to the pump body as including a living hinge. A hollow pump piston defines a discharge passage lying perpendicular to the central axis of the closure, and an elastomeric element may be provided with functions as a piston return spring, inlet check valve and discharge check valve.

### BACKGROUND OF THE INVENTION

This invention relates generally to trigger actuated pump sprayers, and more particularly to such sprayers having unique features which significantly reduce the cost of production and assembly given the fewer number of component parts and the efficiencies developed compared to known trigger actuated sprayers.

The manually actuated pump sprayer to which the present invention is directed is trigger actuated for reciprocation of the piston within a pump cylinder and may be used for the dispensing of a wide variety of, for example, liquid household products. Low-cost trigger actuated sprayers are known which require a specially molded container to which the sprayer is attached or a specially molded pump housing which, in either case, result in higher, rather than lower, production and assembly costs. And, many of the known trigger actuated pump sprayers are of somewhat complex design of the sub-assembly components which only adds to the cost of molding.

### SUMMARY OF THE INVENTION

It is therefore an object of the present invention to provide a trigger actuated pump sprayer of reduced cost with fewer component parts yet highly reliable, versatile, easy to mold and assemble, and highly effective in operation.

The trigger sprayer of the invention is of the in-line variety in which a hollow piston operates within a pump cylinder with the piston defining a discharge passage lying substantially perpendicular to the center line the container closure provided for mounting the pump sprayer to the neck of the container of liquid product to be sprayed. The sprayer has a pump body which includes the pump cylinder, and the container closure may be formed integrally with the pump body or may be formed separate therefrom. A seal ring acts between the pump body and the container neck, the ring being either a separate seal washer or being formed integrally with the pump body as a plug seal for plugging into the container neck on assembly. A shroud cover is provided which may be a separate element coupled to the pump body, or which may be formed integrally with the pump body. An inlet check valve is provided within the pump body for inletting the liquid product into the pump chamber, and a one-way discharge valve is provided for controlling the discharge of the liquid product from the pump chamber through the discharge orifice of a spray nozzle cap mounted on a forward end of hollow piston. A trigger lever is coupled to the pump body and engages the piston for reciprocation thereof upon trigger actuation. In one embodiment the trigger actuator has an end cap coupled to the pump body and has an upper section to which the lever is hinged via a living hinge. The upper section may be received within a front open end of the shroud cover. In accordance with other embodiments of the invention, the trigger lever is hingedly mounted to the pump body as by trunnions on the lever received within trunnion supports on the pump body, with the shroud cover overlying the hinged connection for retaining the hinged lever in place. The inlet check valve may be retained in place by bearing against a turn of a coil spring provided as a return spring for the piston, or may be snap-fitted within a groove formed within the pump body.

Otherwise, an elastic diaphragm may be provided which functions as a spring bias for the piston, and which includes an annular inlet check valve seated within a upstream end of the cylinder bore. The elastic diaphragm likewise functions as a discharge valve as a cylindrical side wall thereof cooperates with a hollow stem portion of the piston.

The hollow piston may have an integral nozzle adapter formed therewith, or may have a separate nozzle adapter which cooperates with the discharge valve having a spin mechanics feature. A rotatable spray nozzle cap overlies the discharge valve/spin mechanics element which may control the discharge between spray/off and stream/off. And, the container may be of the internally threaded variety, or may be of the snap-fit or snap-fit/turn varieties.

Other objects, advantages and novel features of the invention will become more apparent from the following detailed description of the invention when taken in conjunction with the accompanying drawings.

### BRIEF DESCRIPTION OF THE DRAWINGS

FIG. 1 is an expanded perspective view of a low cost trigger actuated pump sprayer in accordance with one embodiment of the invention;

FIG. 2 is a vertical sectional view of the FIG. 1 pump sprayer as assembled together, at a slightly enlarged scale;

FIG. 3 is an expanded perspective view of another embodiment of the invention;

FIG. 4 is a vertical sectional view of the FIG. 3 sprayer as assembled together, at a slightly enlarged scale;

FIG. 5 is an expanded elevational view of yet another embodiment of the invention;

FIG. 6 is a sub-assembly vertical, part sectional view of several components of the sprayer of FIG. 5.

### DETAILED DESCRIPTION OF THE INVENTION

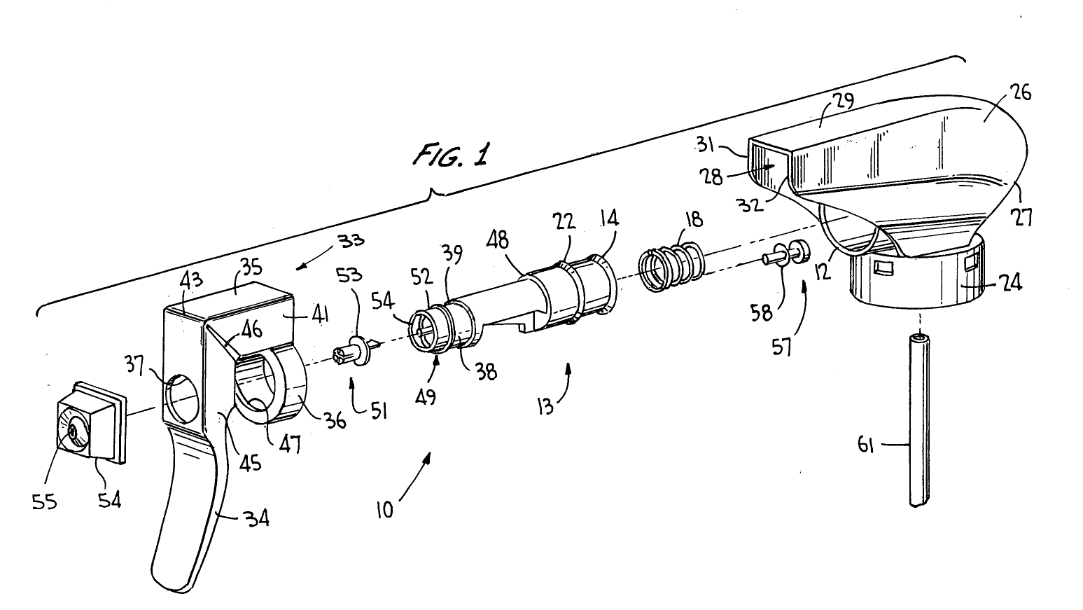

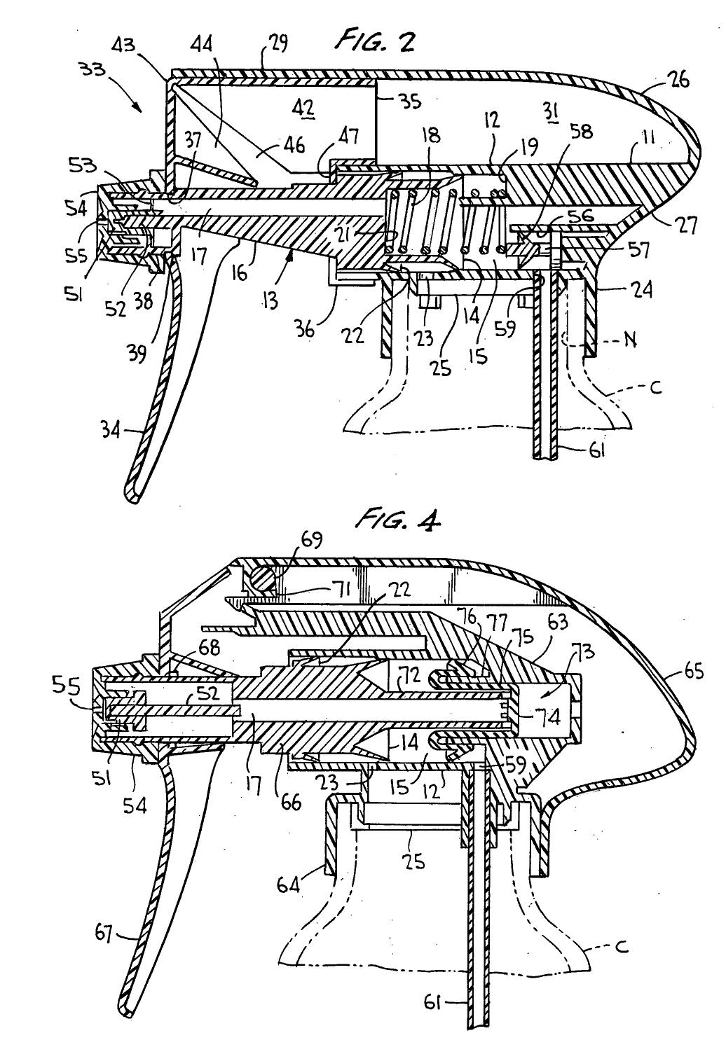

Turning now to the drawings wherein like reference characters refer to like and corresponding parts throughout the several views, an embodiment of a low-cost trigger sprayer according to the invention is shown in expanded view in FIG. 1 and is generally designated 10, and is shown assembled in FIG. 2. It should be pointed out that the term “sprayer” is broadly used herein to include a manually actuated pump which discharges liquid product as either a spray or a stream. Likewise, the term “sprayed” or the like includes discharge as either a spray or a stream.

Sprayer 10 generally comprises a pump body 11 which includes a pump cylinder 12 for the reception of a hollow piston 13 having its piston seal 14 in engagement with the interior of the cylinder for reciprocation to therewith define a variable volume pump chamber 15. The piston has a hollow stem 15 defining a discharge passage 17. A coil spring 18 spring biases the piston out of its cylinder and extends between an inner end 19 of the pump cylinder and a shoulder 21 of the piston. The piston likewise has an outboard vent seal 22 in engagement with the wall of the cylinder outboard of chamber 15. The vent seal is provided for covering and uncovering a vent port 23 located in the cylinder wall, the port being in open communication with the interior of container C to which the pump is mounted. The vent seal is similar to that disclosed in Reissue Pat. No. 33235 and in U.S. Pat. No. 4,072,252 for opening and closing a vent port during piston reciprocation. In the FIGS. 1, 2 embodiment, pump body 11 includes an integral container closure 24. The closure is configured for snap-fit engagement with neck N of container C for mounting pump sprayer 10 to the container of liquid product to be sprayed. And, formed integrally with the pump body is a plug seal 25 comprising an annular seal ring having an outwardly chamfered edge to facilitate plugging the seal into the interior of the container neck on assembly, thereby avoiding the need for a separate seal gasket.

Pump body 11, in the FIGS. 1, 2 embodiment, likewise has an integral shroud cover 26 configured to have a rearward extension 27 adapted to rest on the hand of the operator for supporting a connected, liquid filled container, when operating the trigger sprayer. The shroud cover, as more clearly shown in FIG. 1, likewise has an open front area 28 of a predetermined cross-section which, as shown, may be substantially U-shaped forming a top wall 29 and opposing side walls 31, 32.

Pump sprayer 10 further includes a trigger lever assembly 33 of one-piece molded construction which includes a trigger lever 34 having an upper support section 35 and an end cap 36. The trigger lever has an opening 37 through which hollow piston 13 extends as shown in the FIG. 2 assembled position. Opening 37 is sized to snugly engage cylindrical portion 38 of the piston, and the edge of opening 37 bears against a shoulder 39 on the piston for translating reciprocation movement to the piston upon trigger actuation.

Upper section 35 is of a complementary shape to that of open front area 28 of the shroud cover so as to snugly fit within the front area defined by walls 29, 31, 33. Opposing side walls 41, 42 of upper section 35 are parallel to walls 31, 32 of the shroud, and upper section 35 is integrally connected to trigger lever 34 via a living hinge 43. The trigger lever may be formed with opposing upper side walls 44, 45 for rigidity purposes, confronting edges of side walls 44, 42 and of side walls 45, 41 being sloped so as to form a predetermined angle 46 therebetween in the relaxed position of the trigger lever of FIG. 2 to thereby permit the trigger lever to pivot during pump actuation relative to upper section 35 without interference between these side walls which generally lie in the same plane.

End cap 36 is sized to snugly surround and engage pump cylinder 12 for mounting assembly 33 to the pump body. The end cap may be further welded to the pump cylinder or snap-fitted thereto, as optional. And, the end cap has an annular flange 47 which defines an end stop for the pump piston as shoulder 48 thereon bears against flange 47 at the end of the piston suction stroke for limiting the extent of the piston stroke and for capturing the piston within its pump cylinder on assembly.

Leading end 49 of the pump piston extends through opening 37 of the trigger sprayer, and a discharge valve/spin mechanics element 51 having a central depression is mounted on stem 52 extending in an axial direction within the pump piston. Element 51 is provided with a discharge valve seal 53 which may extend radially or conically in a forward direction and which is seated against inner cylindrical wall 54 at leading end 49. Element 51 compares with plug element 16 of U.S. Pat. No. 4,706,888, the entire disclosure of which is incorporated specifically herein by reference. Thus, element 51 defines a spin chamber at its forward end, longitudinal grooves, and radial/tangential grooves for creating a spray of stream depending on the rotational position of a nozzle cap 54 mounted on leading end 49 with snap fit engagement, and having an inner cylindrical sleeve, as similarly shown in the U.S. Pat. No. 4,706,888 patent, with similar longitudinal grooves for the control of the discharge of product from discharge passage 17 through discharge orifices 55 in the nozzle cap.

The pump body has an internal cylindrical section 56 for the reception of an inlet check valve 57 having an inlet valve seal 58 which may extend radially or conically in a forward direction and which is seated against the wall of cylindrical section 56 in the relaxed position of FIG. 2.

Finally, the pump body has an inlet port 59 opening into cylindrical section 56, and a dip tube 61 extending from the inlet port into the liquid product within the container. And, it is to be noted that inlet valve 57 is retained within section 56 by the innermost turn of coil spring 18 which bears thereagainst, as shown in FIG. 2.

It becomes evident from the forgoing that the various components making up the trigger sprayer 10 are essentially in line with one another for ease in assembly. Besides, there are a limited number of component parts which comprise the sprayer assembly itself. Thus, on assembly, inlet valve 57 is inserted, followed by the return spring, the pump piston, the trigger lever assembly and the nozzle cap which extends over element 51 mounted at the end of the pump piston. The trigger lever assembly may be frictionally fitted to the pump body and shroud cover, or may be welded thereto along confronting surfaces and edges or may be snap-fitted in place, if it becomes necessary. Otherwise, certainly, it can be glued in place as an option.

In operation, with the dip tube mounted in place as shown in FIG. 2 and extending into the product located in the container to which the pump sprayer is mounted, and assuming the pump chamber primed with liquid to be sprayed, on each manual pull of the trigger the pump piston reciprocates within its cylinder against the bias of the return spring. During each pressure stroke of the piston, the one-way inlet check valve prevents the liquid from returning to the container through the inlet port, and product under pressure flows through the discharge passage as controlled by the discharge check valve for issuing through the discharge orifice as a spray or a stream, depending on the rotative position of the nozzle cap. Flange 57 of end cap 36 serves as a limit stop for the pump piston at the end of its suction stroke shown in FIG. 2 during which product is drawn into the pump chamber through the inlet port and an open inlet valve, as known in the art. The trigger lever at its opening 37 bears against shoulder 39 of the pump piston for reciprocating the piston as well as the spray nozzle as permitted by open angle 46 of the trigger lever assembly which avoids any interference when actuating the trigger lever.

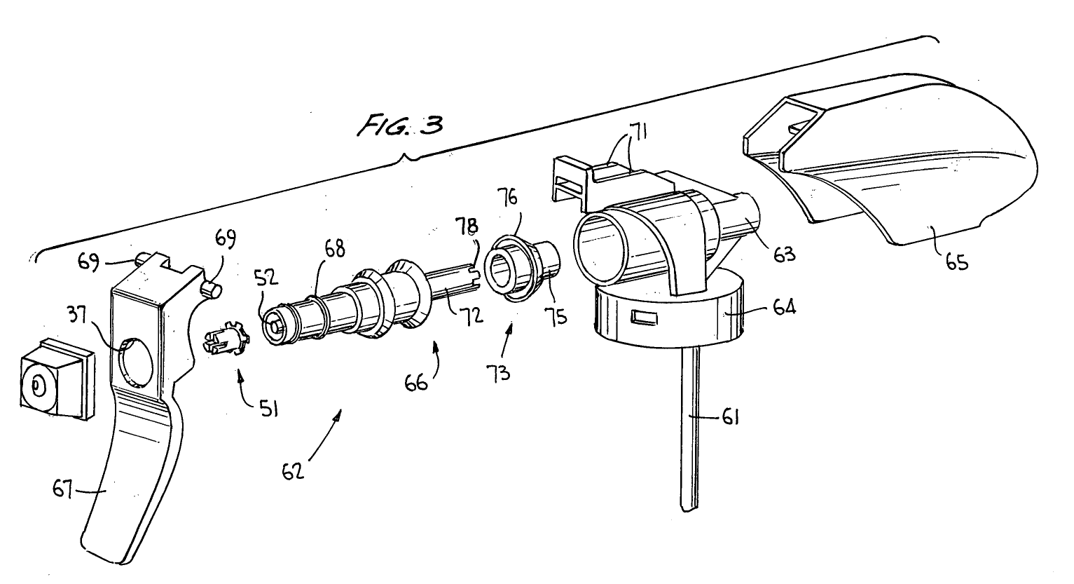

In accordance with another embodiment of the invention is a trigger actuated pump sprayer generally designated 62 shown in FIGS. 3 and 4 which includes a pump body 63 having an integrally formed container closure 64, except that shroud 65 in this embodiment is separate from the pump body/container closure and is coupled thereto as in any normal manner. Thus, sprayer 10 of the first embodiment could likewise have a separate shroud coupled to the pump body in known manner, without departing from the invention. The pump body has a pump cylinder 12 with a vent port 23 and an inlet port 59 similar to that of FIG. 2, a hollow piston 66 being received within its pump cylinder for reciprocation. The piston has a piston seal 14 and a vent seal 22 which operate the same as in FIG. 2, and the leading end of the piston extends through an opening 37 in trigger lever 67 and, as similarly in the first embodiment, the trigger lever at the edge of opening 37 engages a rib 68 on the piston to effect reciprocal movement thereof upon a pulling of the trigger, as will be described in more detail hereinafter.

Discharge valve/spin mechanics element 51 is mounted on stem 52, and nozzle cap 54 is mounted on the leading end of the piston, as in FIG. 2. Trigger lever 67 has a pair of lateral extending trunnions 69 for hingedly mounting the trigger to the pump body as the trunnions are received on a trunnion support 71 of the pump body. The shroud cover at its forward end overlies the trunnion when seated in place to retain it there. The pump piston may be identical to that of piston 13 of FIG. 2 spring biased by a coil spring such as 18 and having a separate inlet check valve 57, except that the cover shroud would be separate from the pump body, and the trigger lever would be trunnion mounted in place to the pump body, rather than mounted as described with reference to FIG. 2.

The embodiment of FIGS. 3, 4 varies from the standard piston in that the piston is provided with an elongated stem 72, and a stretchable, elastomeric valve 73 is provided in this embodiment. The elastomeric valve has a central base section 74, a cylindrical side wall 75, and a forwardly sloping conical inlet valve seal 76. The valve seal is mounted on a cylindrical skirt 77 in the pump body, and the thickness of side wall 75 of the elastomeric valve is less than the space between stem 72 and skirt 77. Likewise, the free end of stem 72 is castellated so as to have a plurality of cutouts 78 as more clearly shown FIG. 3. The elastomeric valve functions as a combined inlet check valve, discharge check valve, and piston return spring. The component parts of the FIGS. 3, 4 embodiment are likewise aligned similarly as in the first embodiment, and the aforedescribed alternative embodiment with a separate shroud cover and trigger lever trunnion mounted in place.

Thus, discharge passage 77 lies substantially perpendicular to the central axis of the container closure. Sprayer 62 with its few component parts is easily assembled in place as the elastomeric valve is mounted on skirt 77 with the piston inserted in its cylinder and the trigger lever trunnion mounted on the pump body followed by a snap fitting of the shroud cover in place to retain the trunnion in place, after which the nozzle cap may be snap fitted onto the leading end of the pump piston which extends through opening 37 in the trigger lever. The pump body, as in FIG. 2, has a plug seal 25, and container closure 64 may be of the type which snap fits into the container neck or which is of the bayonet type in which it is seated against retention lugs and then rotated slightly.

In operation, assuming that pump chamber 15 is primed with liquid product, a pull on the trigger lever by the operator pivots the trigger lever about its trunnion axis and reciprocates the pump piston together with the sprayer nozzle against the bias of the elastomeric element 73. The product within pump chamber 15 is discharged through an annular gap formed between side wall 75 of element 73 and stem 75, through notches 78 at the end of stem 75, along discharge passage 17 and out through discharge orifice 55 in the form of a spray or stream depending on the rotative position of the nozzle cap. As pull pressure against the trigger lever is relaxed, wall 75 of element 73 presses tightly against the confronting stem 75 to close the discharge. During each piston return stroke, inlet valve 76 which is seated against the confronting annular inner wall of the pump chamber, is moved away from that wall in response to a differential in pressure between the expanding pump chamber and the pressure acting on the upstream side of valve 76 to thereby suction product up through dip tube 61 and inlet port 59 and into the pump chamber. Therefore, element 73 functions as a piston return biasing means, an inlet check valve, and a discharge check valve, as a single unit.

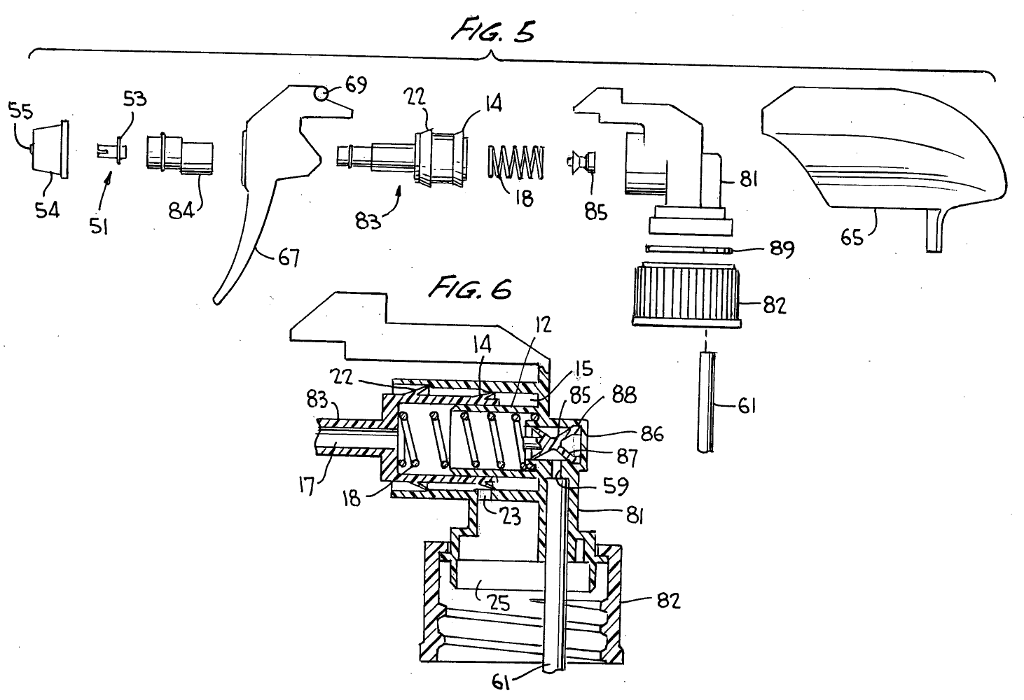

Pump sprayer generally designated 79 in FIG. 5 illustrates a still further embodiment according to the invention which combines features of the FIGS. 2 and 4 embodiments, with several other refinements. Pump body 81 may have an integrally formed container closure 64 as in FIG. 4, or as shown in FIG. 5 may support a separate container closure 82 coupled thereto, which is shown as an internally threaded closure cap. Piston 83 is similar to piston 13 of FIG. 2 except that it has a nozzle adapter 84 which includes a stem 52 mounted at the forward end of the piston, rather than stem 52 being integrally formed with the piston as in FIG. 2. discharge valve/spin mechanics element 51 is the same as in FIG. 2 as is the nozzle cap 54, and trigger lever 67 is trunnion mounted to the pump body as in FIG. 4. The pump body likewise has a plug seal 25 extending into the interior of the container neck, and inlet check valve 85, unlike that of the inlet check valve of FIG. 2, is retained in place within a cylindrical section as the upstream end of pump cylinder 12 as an upstream end 87 of the inlet valve snaps within an annular groove 88. Assembly and operation of the embodiment according to FIGS. 5, 6 are similar to that described hereinabove for the other embodiments.

A gasket seal 89 acting between the pump body and the top of the container neck may be provided in lieu of plug seal 25, and as mentioned above, the pump body may have an integrally formed closure such as 24 or 64 as in FIGS. 2 and 4. Otherwise, the pump body, closure and shroud cover may be formed of a single molded integral part, similarly as in FIG. 2.

From the foregoing it can be seen that a low-cost trigger actuated pump sprayer having a minimum number of component parts acting essentially in-line has been devised a line for several alternate features as shown by the several embodiments in a manner which is highly economical, easy to mold and produce as to assemble, yet highly efficient in this operation and production. It is therefore to be understood that within the scope of the appended claims the invention may be practiced otherwise than as specifically described.

What is claimed is:

1. A manually operated pump sprayer, comprising a pump body having an integrally formed pump cylinder and an integrally formed container closure for mounting the sprayer on a container of liquid to be sprayed, a hollow piston defining a discharge passage, the piston being reciprocable against the bias of piston biasing means upon actuation of a hinged trigger lever relative to the cylinder to therewith define a variable volume pump chamber, the piston and the cylinder lying along an axis substantially perpendicular to a central axis of the closure, an inlet check valve for inletting of liquid product into the pump chamber, a spray nozzle mounted at a forward end of said piston for reciprocable movement together therewith, and the trigger lever engaging the piston for reciprocation thereof upon trigger lever operation for spraying liquid through the nozzle.

2. The pump sprayer according to claim 1, wherein the trigger lever is mounted on the pump body piston and has an integral end cap engaging the pump body for mounting the trigger lever thereto.

3. The pump sprayer according to claim 1, further comprising a shroud cover mounted on the pump body.

4. The pump sprayer according to claim 1, wherein the trigger lever has a support member which includes the end cap coaxial with the piston.

5. The pump sprayer according to claim 3, wherein the shroud cover is integral with the pump body.

6. The pump sprayer according to claim 4, wherein the shroud cover is integral with the pump body.

7. The pump sprayer according to claim 4, wherein the trigger lever is connected to the support member by a living hinge.

8. The pump sprayer according to claim 1, wherein the inlet valve comprises a separate valve element having an annular valve flange seated against a tubular section of the valve body.

9. The pump sprayer according to claim 8, wherein the piston biasing means comprises a coil spring, and wherein the valve element is arranged as to be retained within the tubular section by the piston return spring.

10. The pump sprayer according to claim 1, wherein the container closure has a container engaging skirt and an integral concentric annular seal arranged to plug into a neck of the container.

11. The pump sprayer according to claim 4, wherein the support member fits within a front end of the shroud cover.

12. The pump sprayer according to claim 1, wherein the trigger lever is hingedly mounted to the pump body.

13. The pump sprayer according to claim 1, wherein the trigger lever is mounted to the pump body on open hinge supports, the pump sprayer further comprising a shroud cover mounted on the pump body, the trigger lever being trunnion mounted on said hinge supports, and the shroud cover overlying the hinge supports for retaining the trunnions in place.

14. The pump sprayer according to claim 1, wherein the trigger lever is mounted to the pump body on open hinge supports and is retained hingedly mounted in place by the provision of a shroud cover mounted on the pump body.

15. The pump sprayer according to claim 1, wherein the piston biasing means comprises a coil spring.

16. The pump sprayer according to claim 1, wherein the piston biasing means comprises an elastic diaphragm with said inlet valve integrally formed therewith.

17. The pump sprayer according to claim 16, wherein said inlet valve comprises an annular valve flange normally seated against an inner wall of the pump cylinder.

18. The pump sprayer according to claim 16, wherein the elastic diaphragm valve has a side wall which cooperates with a stem portion of the hollow piston to therewith define a discharge valve.

19. A manually operable pump sprayer adapted to be mounted on a container neck of a container of liquid to be sprayed, comprising, a pump body having a pump cylinder and an integrally formed container closure, a hollow piston reciprocable against the bias of a spring within the pump cylinder to therewith define a variable volume chamber, the piston defining a discharge passage having a spray nozzle at one end thereof, an actuation assembly mounted on the pump body, the assembly comprising a trigger lever having a end cap coaxial with said piston, the trigger lever being hinged connected to an upper wall section of the assembly and engaging the piston for reciprocation thereof, a spray nozzle mounted on a forward end of the piston at a location downstream of the trigger lever and an inlet check valve for inletting liquid product into the pump chamber.

20. The pump sprayer according to claim 19, further comprising a vent port in said pump body and in communication with the container interior at a location downstream of said pump chamber, and means on said piston for opening and closing the vent port respectively during pressure and suction strokes of the piston.

21. The pump sprayer according to claim 19, wherein the end cap defines a limit stop for the piston at the end of the suction stroke thereof.

22. The pump sprayer according to claim 19, further comprising a shroud cover integral with the pump body.

23. The pump sprayer according to claim 22, wherein the shroud cover overlies the upper wall section of the actuation assembly.

24. The pump sprayer according to claim 19, wherein the trigger lever is hinged to the upper wall section by an integral living hinge.

25. The pump sprayer according to claim 19, wherein the inlet check valve is retained in place by the spring.

26. A manually operable pump sprayer adapted to be mounted on a container neck of a container of liquid to be dispensed, comprising a pump body having a pump cylinder and an integrally formed container closure, a shroud cover coupled to the pump body, a hollow piston reciprocable against the bias of a spring within the pump cylinder to therewith define a variable volume pump chamber, the piston and the cylinder lying perpendicular to a central axis of the closure, the piston defining a discharge passage having a spray nozzle at one end thereof, a trigger lever hingedly mounted on the pump body and engaging the piston for reciprocation thereof between pressure and suction strokes, the trigger lever having trunnions in hinged engagement with trunnion supports on the pump body, the shroud cover overlying the trunnion supports for retaining the trunnions in place, and the pump body having an inlet check valve for inletting liquid product into the pump chamber upon trigger lever actuation.

27. The pump sprayer according to claim 26, wherein the inlet check valve is retained in place by the spring.

28. The pump sprayer according to claim 26, wherein the closure has an integral plug seal for sealing engagement with the inside of the container neck.

29. The pump sprayer according to claim 26, wherein the pump cylinder has a vent portion communication with the interior of the container, the port being located downstream of the pump chamber, and means for opening and closing the port to atmosphere respectively during the pressure and suction strokes of the piston.

30. A manually operable pump sprayer adapted to be mounted on a container neck of a container of liquid product to be sprayed, comprising a pump body having a pump cylinder and an integrally formed container closure, a shroud cover coupled to the pump body, a hollow piston reciprocable within the pump cylinder to therewith define a variable volume pump chamber, the hollow piston defining a discharge passage lying perpendicular to a central axis of the closure, an elastic diaphragm supported within the pump body, the piston having an elongated hollow stem in engagement with a central portion of the diaphragm to thereby spring bias the piston during pressure and suction strokes thereof, the diaphragm comprising an inlet check valve for inletting liquid product into the pump chamber and comprising a discharge check valve for controlling discharge of liquid product from the pump chamber and into the discharge passage, a spray nozzle on an end of the piston, and a trigger lever having trunnions in hinged engagement with trunnion supports on the pump body, the shroud cover overlying the trunnion supports for retaining the trunnion in place.

31. The pump sprayer according to claim 30, wherein said inlet check valve comprises an integral annular valve flange of said diaphragm seated against an inner wall of said cylinder.

32. The pump sprayer according to claim 30, wherein said discharge valve comprises a cylindrical portion of said diaphragm seated against said hollow stem.

33. A manually operable pump sprayer adapted to be mounted on a container of liquid product to be sprayed, comprising a pump body having a pump cylinder, a seal acting between the pump body and a neck of the container, a container closure coupled to the pump body, a hollow piston reciprocable against the bias of a return spring within the pump cylinder to therewith define a variable volume pump chamber, the piston defining a discharge passage having a spray nozzle assembly mounted at a forward end thereof, the discharge passage lying perpendicular to a central axis of the closure, a trigger lever actuator connected to said pump body by a hinged connection, said actuator being in engagement with the piston for reciprocation thereof, a shroud cover coupled to said pump body, an inlet valve supported within said pump body for the inletting of liquid product into said pump chamber, and said nozzle assembly including a discharge valve for controlling the discharge of the liquid product from said pump chamber.

34. The pump sprayer according to claim 33, wherein said nozzle assembly further comprises a nozzle adapter and a spin mechanics element.

35. The pump sprayer according to claim 34, wherein said discharge valve is integrally formed with said spin mechanics element.

36. The pump sprayer according to claim 33, wherein the seal comprises an annular plug seal integral with said pump body for plugging into the neck of the container.

37. A manually operated pump sprayer adapted to be mounted on a container neck of a container of liquid product to be sprayed, comprising, a pump body having a pump cylinder, an integrally formed container closure and an integrally formed shroud cover, a hollow piston reciprocable against the bias of a spring within the pump cylinder to therewith define a variable volume pump chamber, the piston defining a discharge passage lying perpendicular to a central axis of the closure, a spray nozzle assembly on a forward end of the piston, a trigger lever hingedly connected to said pump body and engaging said piston for reciprocation thereof, a seal acting between the pump body and the container neck, an inlet check valve supported within said pump body for inletting of the liquid product into said pump chamber, and said spray nozzle assembly including a one-way discharge valve for controlling discharge of the liquid product from said pump chamber.

38. The pump sprayer according to claim 37, wherein said nozzle assembly includes a spray nozzle and a spin mechanics element formed integrally with said discharge valve.

39. The pump sprayer according to claim 38, wherein said nozzle assembly further includes a nozzle adapter supporting said spin mechanics element.

40. The pump sprayer according to claim 38, wherein the seal comprises an annular plug seal integral with said pump body for plugging into the neck of the container.
